(19) United States
(12) Patent Application Publication
(10) Pub. No.: US 2014/0106120 A1
(43) Pub. Date: Apr. 17, 2014

(54) TWO-DIMENSIONAL COMPOSITE ELEMENT

(71) Applicant: Patrick Slavicek, Friedrichsdorf (DE)

(72) Inventor: Patrick Slavicek, Friedrichsdorf (DE)

(73) Assignee: PLS SOLUTIONS GMBH, Friedrichsdorf (DE)

(21) Appl. No.: 14/112,974

(22) PCT Filed: Apr. 13, 2012
(86) PCT No.: PCT/EP12/01617

§ 371 Date: Dec. 29, 2013

(30) Foreign Application Priority Data
Apr. 19, 2011 (DE) 10 2011 018 219.5

(51) Int. Cl. B32B 5/24; B32B 25/08; B32B 7/02

(52) U.S. Cl. CPC B32B 5/245; B32B 7/02; B32B 25/08
USPC 428/138; 428/339; 442/340; 428/319.3

(57) ABSTRACT

Sheet-like composite element comprising
a) at least one layer of a textile web or a non-woven based on microfibers with a fineness of at most 1 dtex,
b) at least one layer made of a pressure dampening materials, and
c) at least one layer of a polymeric material, the coefficient of friction of which on a given surface exceeds the coefficient of friction of layer a) on the same surface and measured under identical conditions by at least 30%.

The present invention relates to a sheet-like composite element having at least three different layers.

DE 295 15 667 discloses elastic non-slip grip aids which serve to provide a secure grip between the human hand and an object to be handled or manipulated. These grip aids in the form of a cloth, a woven fabric, a mat or in the form of gloves comprise knobs in the form of cylindrical stumps on both sides (the side facing the hand and the side facing away from the hand), which preferably have a height of approximately 1 mm. These grip aids improve the grip but have the disadvantage that the knobs facing the hand result in compressive loads and pressure marks in the hand of the user upon circumferentially holding same for extended periods of time. In addition, such knob-structures are difficult to clean.

From DE 86 13 545 a grip aid in glove form with adhesion improving means for the handling of rigs during windsurfing is known where the power transmission is improved by providing a hook and loop adhesive fabric on the interior side of the grip aid and where parts of the rig comprise a complementary hook and loop fabric. These grip aids are not suitable and are too complicated in the use, however, for improvement of the grip of the human hand in particular on smooth surfaces such as sports equipment. In addition, during use, dust and contaminations accumulate in the hook and loop fabric which is not readily accepted by the users of respective sports equipment.

From DE 20 2008 001 385 textile grip aids for fitness equipment are known, which are used hygiene-protective coatings.

In DE 296 03 630 grip cushions for athletes useful for training with fitness equipment and dumb-bells are known, consisting of a polyurethane foam with defined properties. These grip cushions improve the adhesion between the hand of the athlete and the equipment but the products, due to their thickness of at least 10 mm are comparatively rigid and the haptics (surface-feel) of the polyurethane foam is considered uncomfortable by the user. In addition, the adhesion (static friction) of the polyurethane foam on the surface of the dumb-bell or the fitness tool (which is usually a metallic surface) is not fully satisfactory.

DE 203 10 158 discloses a sheet-like aid for the manipulation of screw caps and the manipulation of household articles and instruments are known which consist of a multilayered composite element on a carrier material. The carrier material comprises a covering layer of latex or latex-containing components on both sides or is fully surrounded by a respective covering layer, wherein the surface of the covering layer has an open-pore structure. By virtue of this open-pore structure it is intended to create a suction-effect which should prevent a sliding-off of the hand of the user. In addition, the pores are intended to absorb sweat depositions. Again, these products lead to an uncomfortable haptic feeling for the user and the significant sweat deposition can lead to undesirable bacterial odor-formation.

For the use in the sports and fitness area there are also known leather gloves comprising textile components. These products however are subject to a significant wear and deterioration caused by mandatory seams on the inner side which are destroyed by the friction with the dumbbells or the fitness equipment. In addition, it can hardly be avoided that wrinkles are formed in the glove material during the training which, in combination with the sweat production, due to the increased sensitivity of the skin under these conditions, result in pains for the user caused by the formation of bubbles or injuries of the inner side of the hand of the user.

Thus, there still exists a need for tools for the manipulation or handling of objects, in particular in sports and fitness facilities which tools provide on one hand the secure grip between the hand of the user and the object or equipment to be manipulated and on the other hand do not show the disadvantages described above.

In the sports and gymnastics area mats are known which are used by the athlete to conduct exercises while sitting or laying down. Such mats on one hand should provide a sufficient friction adhesion with the surface they are positioned on to prevent a movement of the mat during the exercise as such movement carries the risk of injuries. Furthermore, such mats are also intended to thermally isolate the athlete from the usually cold surface on which such mats are layered (usually floors or the like) to reduce the risks of getting colds and injuries. The surface with which the athlete comes into contact should have a comfortable skin-effect and haptics. A further requirement for the surface facing the user is the capability to reversibly absorb moisture or fluids (like body sweat of the user).

DE 76 12 838 discloses an exercise and playing mat with a core of a foamed resin with a sheet-like textile material covering on one surface and a slip-reducing sheet like material on the other surface.

It was therefore an object of the present invention to provide respective products for the applications described above.

This object is achieved in accordance with the invention by the sheet-like composite elements in accordance with claim 1. Preferred embodiments of the present invention are set forth in the dependent claims and the detailed specification hereinafter.

The term “sheet-like” as used herein is intended to denote elements the dimensions of which in two dimensions which form a plane are significantly larger than in the third dimension. Elements of this type frequency are also referred to as plate-shaped.

The sheet-like composite elements in accordance with the present invention comprise a first layer a) based on microfibers or microfilaments with a yarn count (fineness) of at most 1 dtex.

The skilled person would interpret the term microfiber as a collection of fibers which are very fine and very thin, which is reflected in the yarn count or fineness. Microfibers have a thickness which is significantly smaller than the diameter of a human hair and they are also thinner than the thinnest known natural fibers based on silk. The yarn count or fineness indicates the mass of a single fiber having a length of 10,000 m, i.e. a yarn count of 1.0 dtex indicates a fiber having a mass of 1 gram at a length of 10,000 m.

Preferred microfibers for use in the composite elements in accordance with the present invention have a yarn count in the range of from 0.01 to 0.9, in particular in the range of from 0.1 to 0.8 dtex.

Fine microfibers are usually combined and drawn into one thread to be used in the respective application, which produces a very soft structure on one hand but retains the dimensional stability on the other hand.

The layer a) can be present in the form of a textile web or in the form of a non-woven of microfibers or microfilaments. The term textile web is the summary term for textile sheet-like formations comprising at least two perpendicular or nearly perpendicularly crossed yarn systems. The two yarn systems also have a relative orientation towards each other, i.e. the arrangement of single fibers is predetermined. On the other hand, non-wovens consist of fibers the orientation and arrangement of which can only described with statistical methods. The english term non-woven thus clearly delimits same from textile webs. Non-wovens are frequently also referred to as randomly oriented fiber mats.

Microfibers may be obtained from all important fiber raw materials and respective products are known to the person skilled in the art and are commercially available, so that no further detailed explanations are necessary here. Generally, synthetic as well as natural fiber raw materials are suitable.

Commercially available products comprise frequently microfibers based on polyesters or polyamides. In addition, the skilled person knows microfiber products based on polyacrylonitrile and cellulose to mention only two additional examples.

Leather-like microfiber textile webs or non-wovens on the basis of polyesters or polyamides have an appearance resembling natural leather and also show a respective comfortable haptics upon holding. The comfortable grip-property for the use can be enhanced by dipping the microfiber material into a polymer matrix, in particular a polyurethane matrix. Respective products show properties related to the grip-feeling and the low weight which are even better than those of natural leather.

Processes for the manufacture of products based on microfibers which can be used as layer a) in the composite elements in accordance with the present invention are also known to the person skilled in the art and have been described in the literature.

By using the so-called direct spin-process microfibers with a yarn count of up to 0.1 dtex can be manufactured; due to the tendency of the single elements to stick together smaller yarn counts cannot be easily produced in this way, however.

In the so-called indirect spin-process in a first step a bicomponent fiber is produced and in a subsequent step one component is dissolved again out of this bicomponent fiber.

Suitable microfiber, respectively microfilament products for use as layer a) in the composite elements in accordance with the present invention are known under the trade names Diolen®-Mikro, Trevira®-Finesse, Trevira® Micronesse (microfibers based on polyesters), Tecter-Micro, Mery® Microfibre (microfibers based on polyamides) (Dralon®-Mikro, Mikro-PAC, Leacril®-Mikro (microfibers based on polyacrylonitrile), Fashmo® (product based on a combination of polyamides and polyurethanes) or Evolon® microfilaments.

For certain specific applications products from the products series Fashmo® (Fashion and More) or Evolon® have proved to be advantageous.

The Fashmo® series of products is based on textile webs made of microfibers form 70 wt % polyamides and 30 wt % polyurethanes with different thicknesses, which thickness is indicated by certain digits. Thus, Fashmo® DS05P has a thickness, measured in accordance with ASTM D1117 in the range of 0.5 mm whereas Fashmo® DS07P has a thickness in the range of 0.7 mm. Further products commercially available are Fashmo® 10 PS, Fashmo® DS12 and Fashmo® DS14 with thicknesses of 1.0, 1.2 and 1.4 mm, respectively. The same supplier also offers products based on 70 wt % polyester and 30 wt % polyurethane under the tradename Chamud® e.

Evolon® is the tradename for products based on microfibers which are available from Freudenberg and are obtained in accordance with a specific process.

The layer a) of the composite elements in accordance with the present invention is located on the side of the element which is facing the hand respectively the body of the user. Thereby a comfortable grip respectively the comfortable skin-feeling for the user is achieved, which persists and does not become uncomfortable during use for extended periods of time as can occur for example upon training with fitness equipment or during gymnastic exercises. Through the property of the microfiber products to absorb humidity the sweat production of the user during the exercise is also accounted for. The high suction-capability of the microfibers to absorb humidity is achieved through the multiplicity of air chambers and small pores in the structure, which results in a capillary effect and the sweat of the user is reliably absorbed by the microfiber. Through subsequent simple washing or drying of the composite elements in accordance with the present invention the absorbed sweat can be removed again from the microfibers.

Through the dull (blunt) surface, high grip values are also obtained by the use of the composite elements in accordance with the present invention as grip aides for fitness tools. In addition the surface of the layer a) is highly resistant against the occurring friction as well as against UV-radiation and in addition has a good breathing activity.

Products based on microfibers or microfilaments which are classified as problem free for direct skin contact according to applicable regulations and which are certified accordingly are preferred as layer a) of the composite elements in accordance with the present invention.

The thickness of layer a) is not subject to specific limitations and can be selected individually as desired by the user. In practical use thicknesses of layer a) in the range of from 0.3 to 1.5 mm, preferably in the range of from 0.4 to 1.2 mm have been found sufficient to achieve the desired properties.

Layer a) of the composite elements in accordance with the invention can be antimicrobially or antistatically equipped dependent on the intended area of use. An antistatic finishing can achieved with the addition of suitable compounds with a sufficient electric conductivity whereas for antimicrobial properties the use of silver compounds has been found useful, which can be added to the textile webs or non-wovens already during their manufacture. Respective products are commercially available and e.g. described in DE 20 2005 010 978.

In accordance with a preferred embodiment the microfiber layer of the composite elements in accordance with the invention can be equipped with very fine holes, also known as microperforation. This can improve the drying of the microfiber and eventually of the layers below the microfiber. The holes are preferably designed in a manner which does not detrimentally influence the haptics of the microfiber layer while at the same time the tear strength is maintained to a sufficient degree. The holes of such microperforations generally have a diameter in the range of from 0.01 to 3 mm, preferably in the range of from 0.1 to 2.5 mm and particularly preferably in the range of from 0.2 to 1.5 mm.

The composite elements in accordance with the invention comprise as layer b) a layer of a material dampening pressure loads. Principally any material showing a sufficient elasticity under pressure load is suitable. The term elasticity as used herein is to be understood as a property of a material to reversibly change its form under the influence of force, i.e. to return to its initial form and structure once the acting force is no longer present.

For weight reasons foams or foamed materials, in particular elastic foams have been found preferable as material for the layer b) of the composite elements in accordance with the invention. These materials on one hand show the desired pressure dampening property and on the other hand it is ascertained that the weight of the composite elements in accordance with the invention is not undesirably high.

The term foams or foamed materials, when used herein, denotes synthetic materials with cellular structure and low density. In principle any plastic materials or polymers can be converted into foams and a huge variety of different products are commercially available. The skilled person in this context knows so-called closed-cell products, in which the walls between the cells are completely closed and for which a liquid absorption is essentially excluded. Open-cell foams in contrast thereto allow the reversible uptake of liquids or fluids to a considerable extent. The absorbed fluid can be removed from the foam at a later point in time by suitable drying methods. Products combining both properties are also known and commercially available. Through the use of a specific material the fluid uptake capability of the layer b) of the composite elements in accordance with the invention can be adjusted to the specific application.

Usually the water uptake properties of layer a) are sufficient to absorb the humidity or fluids in the form of sweat occurring during the use of the composite elements in accordance with the invention in sports or fitness training so that it is not necessary that layer b) is also capable to absorb fluids. Frequently it is even advantageous if the layer b) shows no fluid uptake because the removal of humidity or fluids from foams or foam materials is usually more difficult as the respective removal of humidity or fluids from textile webs or non-wovens based on microfibers or microfilaments as used for layer a). In these cases closed-cell foams are preferably used as base material for the layer b).

If the composite elements in accordance with the invention are however used in applications, in which amounts of fluids have to be absorbed which exceed the uptake capability of layer a) open-cell foams can preferably be used.

For the use of the composite elements in accordance with the invention for sport or gymnastic mats it can be advantageous if the layer b) can also absorb or uptake humidity. In this area of use it has proved to be advantageous if a visco-elastic foam is directly bonded to the microfiber layer. The term visco-elasticity is to be understood to describe the time-, temperature- and frequency-dependent elasticity of a material. Viscoelastic materials show a spontaneous elasticity which is substantially independent of time after form change, while the viscoelastic property of the form change is time dependent. Composite elements in accordance with the present invention with viscoelastic foams adopt their form to the body of the user and convey to the user to a certain degree a feeling of having lost gravity which is considered to be very comfortable during training. If the user lays down on planar mats of a composite element in accordance with the present invention with a viscoelastic foam same appears to be relatively rigid at the beginning. Caused by the body temperature and the weight of the user the material adopts to the body form of the user and the pressure of the body onto the mats is minimized over the entire area of the body, which again is found very comfortable during training. Besides the viscoelastic foam one or more non-viscoelastic foam layers b) can be present in the composite elements in accordance with the invention. This may be advantageous for cost reasons since viscoelastic foams are usually considerably more expensive as foams without viscoelastic properties of the nature described above.

Instead of a viscoelastic foam a non-woven based on fibers can be combined with the microfiber layer if the viscoelastic properties described above are not considered essential and if the primary purpose is to support or increase the humidity or fluid uptake capability of the microfiber layer. A non-woven is understood by the person skilled in the art as a textile sheet like material of loosely assorted fibers which are not bonded to each other.

Instead of a viscoelastic foam or a non-woven and knitted fabrics may be used which are bonded to the microfiber layer.

The term knitted fabric (Wirkware), as understood by the person skilled in the art, is intended to describe materials produced from thread systems by stitching with two types of knitted fabrics being distinguished.

So called weft knitted fabric (Kulierwirkware) is obtained by knitting a single transversally running thread which is taken up by a multiplicity of needles and pulled through the preceding stitch or loop row thereby continuously producing new stitches or loops.

Different from weft knitted fabrics for so called warp knitted fabrics a multiplicity of threads is knitted. The threads run vertically, are taken up by the needles and pulled through the preceding row of stitches or loops. To obtain a sheet like structure, the needles alternatively take up neighbouring threads. A multiplicity of different types of bonding is possible.

Knitted fabrics usually show a good elasticity.

Materials for the manufacture of knitted fabrics are known to the skilled person so that no further detailed explanations are necessary here. Knitted fabrics are also commercially available in a huge number of varieties and the skilled person will select the suitable knitted fabric depending on the desired property profile.

The knitted fabric when used in the composite elements in accordance with the invention can have a variable thickness and a thickness in the range of from 1 to 20 mm has been found useful in certain applications.

The knitted fabric preferably is bound to the microfiber in a suitable manner and may represent layer b) as a whole or may form part of layer b) of the composite elements in accordance with the invention. In the latter case a foam or foamed material as described herein may be arranged subsequently to the knitted fabric layer.

In case of use of a knitted fabric same is preferably bonded in a suitable manner to the microfiber to avoid unraveling or frazzling of the knitted fabric.

The connection between knitted fabric and microfiber is preferably obtained by gluing both materials. In certain cases it has been found useful to sew the knitted fabric with the microfiber in addition to or instead of gluing the materials. Preferably this is achieved by a circumferential seam positioned 1-2 cm apart from the outer boundary of the composite element, any type of seam, in particular any type of ornamental seam being possible.

In case of sewing a projecting boundary of the microfiber is formed, which is preferably reverted and fixed at the bottom side of layer b) of the composite elements in accordance with the invention, preferably glued to the bottom side of layer b).

By using this method in case of sewing seams at the bottom side of the composite element in accordance with the invention can be avoided.

Although the advantages of a layer of viscoelastic foams or non-wovens based on fibers or of knitted fabrics have been described mainly for the use in the area of sports and gymnastic mats it is readily apparent that a respective alignment or design may also be advantageous in case of use of the composite elements in accordance with the invention as grip aids.

Elastic foams are available in different degrees of hardness and by selecting a suitable degree of hardness layer b) of the composite elements in accordance with the invention may be adjusted to the specific habits of the respective user. The rigidity or the degree of hardness of foams is usually defined by the so-called compression strength. The compression strength or compression resistance is determined by measuring the force necessary to compress a foam or foamed material, i.e. to reduce its thickness by a certain percentage. The compression strength is determined in accordance with ISO 7214 (1998). In the course of the present invention compression loads or compression sets in the range of from 10 to 150 kPa, preferably in the range of from 15 to 100 kPa have been found suitable. With these ranges a sufficient rigidity range to adjust to the individual needs of each user is normally covered.

The elastic properties of a foam or foamed material are usually defined by the so called compression set. Compression set is the percentage of deformation, based on the initial deformation, which remains after a certain period of relaxation after the initial deformation. The compression set of particularly suitable foams, measured in accordance with ISO 7214 after an initial deformation of 25% at 23° C. for 22 hours and a subsequent relaxation time of 24 hours is usually in the range of from 1 to 15, preferably in the range of from 2 to 10%.

The raw density of foams or foamed materials can cover a wide range and raw density and degree of rigidity are not necessarily dependent on each other. A heavy foam or foamed material therefore not necessarily has a higher rigidity compared to a foam of from material with a lower density. Accordingly, the density of the foam used for layer b) of the composite elements in accordance with the invention is not particularly critical and can cover the wide range mentioned above. In practice foam densities in the range of from 5 to 150 kg/m³, in particular in the range of from 10 to 100 kg/m³ have been found to be useful.

The type of polymer from which the foam or foamed material is obtained is not particularly critical in the course of the present invention; in principle any foam or foamed material showing the desired combination of properties for the intended application can be used.

Suitable elastic foams or foamed materials, in particular having the densities and compressive strengths described above are commercially available in a multiplicity of variants.

In some cases ethylene/vinyl acetate mixed polymer (copolymer) films have been found useful as material for layer b) of the composite elements in accordance with the invention. Particularly preferably closed-cell, cross-linked products based on ethylene/vinyl acetate-copolymers may be used, which have a raw density in the range of from 20 to 100 kg/m³ and which are commercially available from Zotefoams under the tradename Evazote®. Grades Evazote® VA25, Evazote® VA35, Evazote® VA65 and Evazote® VA 80 may be mentioned here where the numeral designates the raw density of the foam in kg/m³. These products are characterized by a good durability combined with very good dampening properties, even under intense stress over extended periods of time.

Viscoelastic foams or foamed materials have been described in the literature and are commercially available. Sometimes these products are also referred to as slow recovery foams or slow recovery foamed materials. Suitable products are available under the trade names Tempur® or BayFi® t. Such products are preferably foams or foamed materials based on polyurethanes.

Layer b) can also be composed of a combination of different foams or foamed materials with different degrees of rigidity or hardness or densities, thereby allowing the individual adjustment of the dampening properties for the intended use respectively to the individual user.

The thickness of layer b) of the composite elements in accordance with the invention is not subject to specific limitations. In practice thicknesses in the range of from 1 to 5 mm, preferably in the range of from 1.5 to 4 mm have found to be preferable in certain cases to achieve an optimum combination of properties.

The composite elements in accordance with the invention comprise a layer c) of a polymeric material, the coefficient of friction of which on a given surface exceeds the coefficient of friction of layer a) on the same surface (of the object to be manipulated), measured under identical conditions, by at least 30%. This property of layer c) asscertains that the composite elements in accordance with the invention show a good adhesion on the side facing the object to be handled or manipulated and facing away from the hand of the user to the object to be handled or manipulated respectively in the case of sports or gymnastics mats at the surface facing away from the training individual. In particular when using the composite elements in sports and fitness applications a desired slip-reducing effect is realized, which improves the security of the grip, e.g. around a dumb-bell or the like and which improves the protection against sliding away. Thereby a sliding away of the hand from the dumb-bell or generally from the object to be handled or manipulated is effectively prevented and the risk of accidents or injuries is significantly reduced.

The coefficient of friction describes the quotient of the force of friction and the normal force (defined as the force perpendicular to the surface); this coefficient thus defines the magnitude of the force of friction relative to the normal force. The force of friction is defined as the force required to achieve a relative velocity (exceeding a velocity of zero) of layer c) relative to a surface.

Since layer c) does not come into contact with the hand of the user during the use of the composite elements in accordance with the invention, preferably in sports or fitness applications, the haptic properties of the layer c) are not of importance and therefore a optimum and maximum force of friction with the object to be handled or manipulated can be aimed at. Layer c) can, in addition, contribute to the dampening and thereby supplement the effect of layer b).

Advantageously polymeric materials are used for layer c) which show a good durability, which allows to accommodate the mechanical load of the composite elements caused by the desired high degree of friction with the object to be handled or manipulated.

Materials with a low permeability for humidity are preferred as materials for layer c). In particular in case of use of the composite elements in accordance with the invention for sport and fitness applications it can thus be prevented that humidity e.g. arising from formation of sweat of the user has a negative influence on the force of friction with the object to be handled or manipulated. Besides the improved grip security this is also desirable for hygienic reasons to be able to better prevent or reduce sweat depositions on the training equipment.

A number of products are commercially available with which the desired properties described above for layer c) can be achieved.

A class of products particularly suitable as polymeric material for layer c) of the composite elements in accordance with the invention are the so-called chloroprene rubbers, which are commercially available in a huge variety of different grades. In Germany these products are known under the designation or tradename Neopren®. These products are synthetic rubbers based on 2-chloro-1,3-butadien, also known as chloroprene.

By using different foaming agents, which release gases below the temperature of vulcanizing, pressure resistant foamed materials may be obtained. Polychloroprene can be processed with other polymers to polymer blends. With natural rubber or polybutadiene the low-temperature flexibility can be improved and the costs may be reduced and with styrene-butadiene-rubber the tendency to crystallize, which may lead to a undesired brittleness of the product, can be reduced.

In foamed chloroprene rubber a multiplicity of small gas bubbles are regularly distributed which causes this material to show excellent thermal insulation properties.

Chloropren rubbers are available under the tradename Neoprene® from DuPont and under the tradename Baypren® from Lanxess. In some cases products based on chloroprene rubbers obtained from Sedo Chemicals Neoprene GmbH under the tradenames Neopren® LS, S, HS and HHS have been found suitable. The deformation pressure necessary to achieve a thickness reduction of 25% increases in this series from 15-35 to 55-80 kPa) determined in accordance with ASTM D1056).

The composite materials in accordance with the invention comprise at least one of each layers a), b) and c); however, it is equally possible to allow for more than one of each of these layers to adjust the property profile in accordance with the intended application respectively to the individual user.

Dependent on the number of layers the overall thickness of the composite elements in accordance with the invention is usually in the range of from 2 to 25 mm, preferably in the range of from 3 to 15 mm and particularly preferably in the range of from 3 to 10 mm.

The layers of the composite material in accordance with the invention are durably bonded to each other in a manner known per se by gluing our any other suitable bonding process. The bond between the layers has to have a sufficient strength to avoid delamination during use. Gluing processes have been found suitable; the skilled person, however, is also aware of other suitable processes how layers of the type of layers a) to c) can be bonded to each other with sufficient strength. Only by way of example lamination may be mentioned here.

The dimensions of the composite elements in accordance with the invention are not subject to specific limitations and the sheet-like form can have arbitrarily geometric structures, e.g. rectangular, square, elliptic, circular, oval or other known forms.

For the preferred use in sports or fitness applications square or rectangular forms have been found useful as dumb-bells or side rails or the like of fitness equipment can be circumferentially gripped in a secure manner with these geometric forms. The dimensions of the composite elements in accordance with the invention should be chosen in such a manner that the surface of the hand of the user essentially entirely comes into contact with the composite element during use. Sheet-like elements with dimensions in the range of from 80 to 180 mm in both directions of the planar extension and with a total thickness as described above have been found particularly advantageous.

It is readily apparent that other dimensions are possible and necessary in case of use of the composite elements in accordance with the invention as sports or gymnastic mats.

The borders and edges of the composite elements in accordance with the invention may be preferably rounded to achieve a more comfortable use.

From the foregoing description it is apparent that layers a) and c) form the outer layers of the composite element, which cover both surfaces of layer b) (layer a) and c) covering the opposing surfaces of layer b). During use the element is arranged such that layer a) points to the surface of the hand of the user and layer c) points to the surface of the object to be handled or manipulated.

The layers of the composite elements in accordance with the invention may be equipped with imprints or maybe colored for advertising purposes or to distinguish between different product types (e.g. different rigidity or total thickness).

The composite elements furthermore may be equipped at the side facing the hand of the user with fastening elements with which an improved grip of the composite elements with the hand of the user may be secured. Only by way of example loops may be mentioned here.

The composite elements in accordance with the invention are generally suitable for the handling or manipulation of objects of any type where on one hand a comfortable use and on the other hand a secure grip is aimed at. By combination of the various layers and individual adjustment to the intended use or application is easily possible.

The sheet-like composite elements in accordance with the invention are particularly preferably useful as grip aides in the handling or manipulation of sports and fitness equipment, where on one hand a good grip and on the other hand a comfortable haptics for the user is desired.

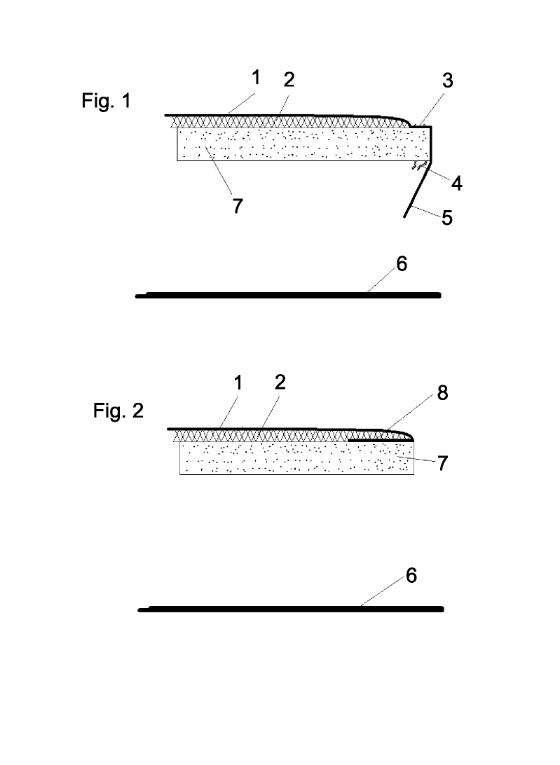

FIGS. 1 to 3 show preferred embodiments of composite elements in accordance with the invention with different possibilities of bonding the layers to each other.

FIG. 1 shows a composite element in accordance with the invention with a microfiber layer 1 and a layer b) of a viscoelastic foam or viscoelastic foamed material, a non-woven based on fibers or a knitted fabric 2 which is stitched to the microfiber layer by an exterior seam 3, which penetrates through a further damping layer 7, i.e. the terminal ends of the seam are projecting out of the lower side of the layer 7 and form an interior seam termination 4. A projecting end 5 of the microfiber layer 1 which is formed by the exterior seam 3 is reverted and glued from the lower side with the layer 7. Subsequently the thus formed partial composite element is completed with a layer c) (reference numeral 6) to the composite element in accordance with the present invention.

FIG. 2 shows a modified embodiment of a composite element in accordance with the invention where a loose end 8 of the microfiber layer 1 is reverted beneath the layer 2 and thereafter the thus obtained element is glued with layer 7. In the embodiment of FIG. 2 it has been found advantageous to revert sufficient material of microfiber layer 2 to increase the loadability of the borders and to improve the stability of the composite element. Reversion widths in the range of from 1 to 8 cm have been found sufficient and preferable in many cases. In this embodiment stitching is usually not necessary and can be dispensed with.

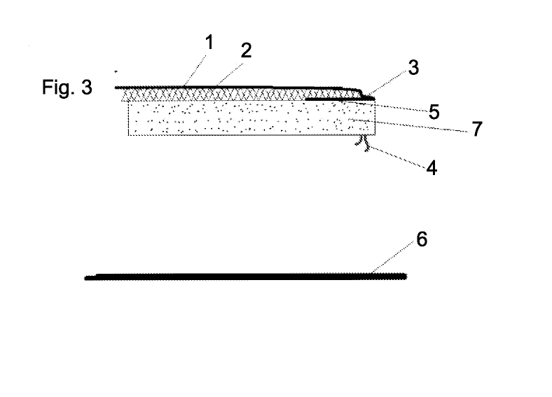

FIG. 3 shows a still further embodiment of a composite element in accordance with the invention. In this case the projecting end 5 of the microfiber, which is formed by the exterior seam 3 is reverted beneath layer 2 (as in the embodiment of FIG. 2) and the seam is guided through layer 7 so that the free seam ends are positioned at the bottom side of layer 7. As in the embodiment in accordance with FIG. 1 all seam terminations are interior.

### EXAMPLE 1

A composite element in accordance with the invention was obtained by gluing in a manner known per se of layers a) to c) as follows:

Layer a): Layer of Fashmo® DS07P of Fashion and More, a textile microfiber web on the basis of 70 wt % polyamide and 30 wt % polyurethane with an planar weight of 230 g/m² and a tearing strength, measured in accordance with ASTM D 2261, of 2.5 kg in both planar directions.

Layer b): 2 mm thick layer of Evazot® e VA 35 (obtained from Zoatefoams), a closed-cell crosslinked ethylene/vinylacetate foam with a raw density of 35 kg/m³ and a compression set (22 h load, 25% deformation, 24 h relaxation time, each measured at 23° C.) of 3.5%.

Layer c): Layer with a thickness of 2 mm of Neoprene® S (Sedo Neoprene Chemicals) with a 25% deformation pressure in accordance with ASTM D-1056 of 25-45 kPa and a density of 170 kg/m³.

This composite element was used in the manipulation and handling of fitness equipment and showed a very good and comfortable handling and haptics for the user combined with a very good grip security. They are a absorbed the sweat of the user in excellent manner, which contributed to the comfortable handling. The humidity absorbed could easily be removed by drying. The composite element showed this preferable property profile after many uses and after several washing cycles.

1. Sheet-like composite element comprising
a) at least one layer of a textile web or a non-woven based on microfibers with a fineness of at most 1 dtex,
b) at least one layer made of a pressure load dampening material, and
c) at least one layer of a polymeric material, the coefficient of friction of which on a given surface exceeds the coefficient of friction of layer a) on the same surface and measured under identical conditions by at least 30%.

2. Sheet-like composite element in accordance with claim 1 wherein layer a) is perforated.

3. Sheet-like composite element in accordance with claim 1 wherein the dampening material of layer b) is a foam or a foamed material.

4. Sheet-like composite element in accordance with claim 3 wherein the foam or foamed material is obtained from a mixed polymer of ethylene and vinyl acetate.

5. Sheet-like composite element in accordance with claim 1 wherein the polymeric material of layer c) is a chloroprene rubber.

6. Sheet like composite element in accordance with claim 1 wherein, a viscoelastic foam, a fibrous non-woven or a knitted fabric is contained as a component of layer b).

7. (canceled)

8. (canceled)

9. (canceled)

10. Sports or gymnastic mat made of a sheet-like composite elements in accordance with claim 1.

11. Grip-aid of a sheet-like composite element in accordance with claim 6 for the manipulation of objects.

12. Grip aid in accordance with claim 11 for use in the handling of fitness equipment.

13. Sheet like composite element in accordance with claim 2 wherein the dampening material of layer b) is a foam or a foamed material.

14. Sheet like composite element in accordance with claim 2 wherein the polymeric material of layer c) is a chloroprene rubber.

15. Sheet like composite element in accordance with claim 3 wherein the polymeric material of layer c) is a chloroprene rubber.

16. Sheet like composite element in accordance with claim 4 wherein the polymeric material of layer c) is a chloroprene rubber.

17. Sheet like composite element in accordance with claim 2 wherein, a viscoelastic foam, a fibrous non-woven or a knitted fabric is contained as a component of layer b).

18. Sheet like composite element in accordance with claim 3 wherein, a viscoelastic foam, a fibrous non-woven or a knitted fabric is contained as a component of layer b).

19. Sheet like composite element in accordance with claim 4 wherein, a viscoelastic foam, a fibrous non-woven or a knitted fabric is contained as a component of layer b).

20. Sheet like composite element in accordance with claim 5 wherein, a viscoelastic foam, a fibrous non-woven or a knitted fabric is contained as a component of layer b).
